(19) United States
(12) Patent Application Publication
(10) Pub. No.: US 2015/0000611 A1
(43) Pub. Date: Jan. 1, 2015

(54) PLAY TOYS AND TECHNIQUES FOR FABRICATING PLAY TOYS

(71) Applicant: JOHN SCOTT COOPER, FORT LAUDERDALE, FL (US)

(72) Inventor: JOHN SCOTT COOPER, FORT LAUDERDALE, FL (US)

(21) Appl. No.: 14/320,165

(22) Filed: Jun. 30, 2014

Related U.S. Application Data
(60) Provisional application No. 61/841,638, filed on Jul. 1, 2013.

(51) Int. Cl. A01K 15/02; A63H 33/30

(52) U.S. Cl. CPC A01K 15/025; A63H 33/30
USPC 119/707; 446/486; 29/428

(57) ABSTRACT

A play toy has at least one stretchable link body having a preselected cross-sectional shape and arranged in a preselected structural configuration. The stretchable body is formed by link members linked together and each having a generally ring-shaped configuration such as in the general form of a donut.

### CROSS-REFERENCE TO RELATED APPLICATION

This application relates to and claims priority benefits from U.S. Provisional Application No. 61/841,638 filed Jul. 1, 2013, which is incorporated herein by reference in its entirety.

### BACKGROUND OF THE INVENTION

1. Field of the Invention

The present invention relates generally to the field of toys and, more specifically, to play toys and techniques for fabricating play toys having link members linked together to form at least one stretchable body or part having a preselected cross-sectional shape and arranged in a preselected structural configuration.

2. Background Information

It is desirable to provide small children and pets with play toys that will entertain and occupy their attention for extended periods of time, as well as play toys adapted for use by individuals with special needs as therapy devices. It is also desirable that such play toys be economical and easy to manufacture, soft to the touch, easily carried and manipulated by children, pets and individuals with special needs, and long-lasting, safe and non-hazardous to play with.

### SUMMARY OF THE INVENTION

Techniques for fabricating play toys having at least one stretchable body or part formed of ring-shaped link members linked together are described herein.

In one aspect, the present invention provides a play toy comprising a plurality of ring-shaped link members linked together to form at least one stretchable link body or part (hereinafter “link body” or “link part”) having a preselected cross-sectional shape and arranged in a preselected structural configuration.

In an exemplary embodiment, each of the link members forming the link body is folded generally about its mid-section to provide two generally aligned looped portions. Each pair of adjacent link members are linked together either at corresponding mid-sections thereof, or by one of the pair of adjacent link members passing through the aligned loop portions of the other of the pair of adjacent link members such that the looped portions of the other of the pair of adjacent link members are positioned in the region of the mid-section of the one of the pair of adjacent link members.

In another aspect, the present invention provides a play toy comprising a combination of one or more of the foregoing link parts and one or more non-linked parts (i.e., parts not formed by link members linked together) connected together to form a three-dimensional-shaped play toy.

In another aspect, the present invention provides a play toy according to any of the abovementioned aspects, and further including one or more sound producing devices arranged in the link part and/or non-linked part for producing an audible noise or sound upon compression or a shaking movement of the sound producing device via the link part and/or non-link part.

In a further aspect, the play toy according to the present invention is particularly adapted for use as a therapy device by individuals with special needs. For example, as a therapy device the play toy according to the present invention can be used as a hand fidget, which instantly calms sensory seekers, as well as a fine motor skill builder.

In exemplary embodiments, the materials for the link part and/or non-link part of the play toy include fleece, plush-like materials, thermoplastic rubber (TPR), denier nylons, recycled materials, all types of fabric and synthetic materials, or combinations of these and other materials. The link part and/or non-link part may also be filled with a suitable filler material including cotton, synthetic fibers, a plastic tubing, a pre-molded structure, or a combination thereof.

In exemplary designs, the inventive techniques are used for fabricating chew, fetch, and tug types of pet toys or combinations thereof, as well as play toys suitable for use by small children and children and adults with special needs.

The foregoing summary is neither intended nor should it be construed as being representative of the full extent and scope of the present invention, which these and additional aspects will become more readily apparent from the detailed description, particularly when taken together with the appended drawings.

### BRIEF DESCRIPTION OF THE DRAWINGS

The foregoing summary, as well as the following detailed description of the preferred embodiments of the invention, will be better understood when read in conjunction with the accompanying drawings. For the purpose of illustrating the invention, there is shown in the drawings embodiments which are presently preferred. It should be understood, however, that the invention is not limited to the precise arrangement and instrumentalities shown. In the drawings:

FIG. 1 is an elevational view of a play toy according to one embodiment of the present invention, the play toy being shown in a natural, unstretched configuration;

FIG. 2 is an elevational view of the play toy of FIG. 1 shown in a stretched configuration;

FIGS. 3A-3B show embodiments of link members used to form one or more link bodies or parts of the play toy according to the present invention;

FIG. 4 is an explanatory perspective view of a link body for the play toy according to the present invention shown in an intermediate stage of manufacture to illustrate an example of the process for linking link members together to form the link body;

FIG. 5 is an explanatory view showing a process of forming a link member for the link body of the play toy according to the present invention;

FIG. 6 is an explanatory view showing another process of forming a link member for the link body of the play toy according to the present invention;

FIG. 7 shows another embodiment of the play toy according to the present invention employing multiple link bodies or parts;

FIG. 8 shows another embodiment of the play toy according to the present invention;

FIGS. 9A-9B are perspective views showing another embodiment of the play toy according to the present invention;

FIG. 10 shows yet another embodiment of the play toy according to the present invention;

FIG. 11 is a perspective view of still another embodiment of the play toy according to the present invention; and

FIG. 12 is an elevational view of a further embodiment of the play toy according to the present invention.

### DETAILED DESCRIPTION OF THE INVENTION

The images in the drawings are simplified for illustrative purposes and are not depicted to scale. To facilitate understanding, identical reference numerals have been used, where possible, to designate identical elements that are common to the figures, except that suffixes may be added, when appropriate, to differentiate such elements.

The appended drawings illustrate exemplary embodiments of the invention and, as such, should not be considered as limiting the scope of the invention that may admit to other equally effective embodiments. It is contemplated that features or steps of one embodiment may be beneficially incorporated in other embodiments without further recitation.

The term “exemplary” is used herein to mean “serving as an example, instance, or illustration.” Any embodiment or design described herein as “exemplary” or “alternative” is not necessarily to be construed as preferred or advantageous over other embodiments or designs.

While the play toys of the present invention are particularly described herein for use as play toys for small children and pets, it will be appreciated that the play toys are also adapted for use as therapy devices by individuals with special needs. For example, as a therapy device the play toy according to the present invention can be used as a hand fidget, which instantly calms sensory seekers, as well as a fine motor skill builder.

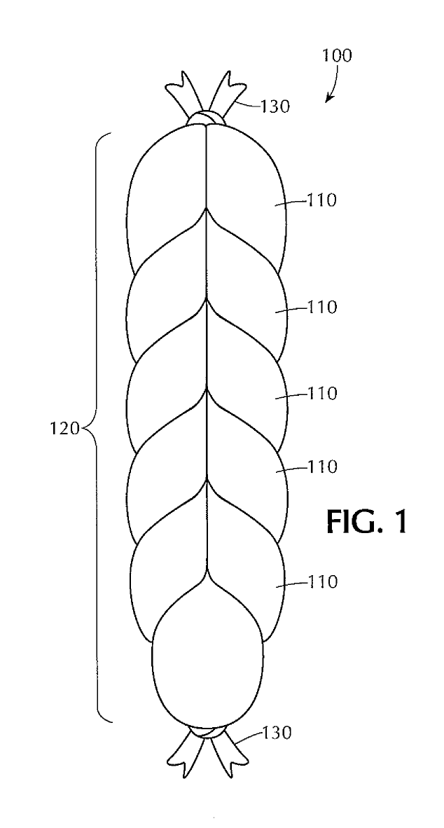

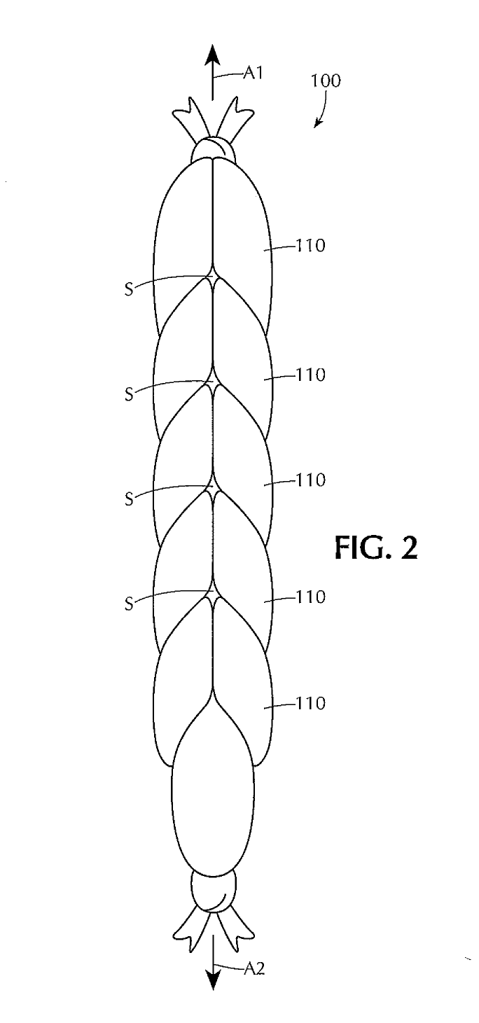

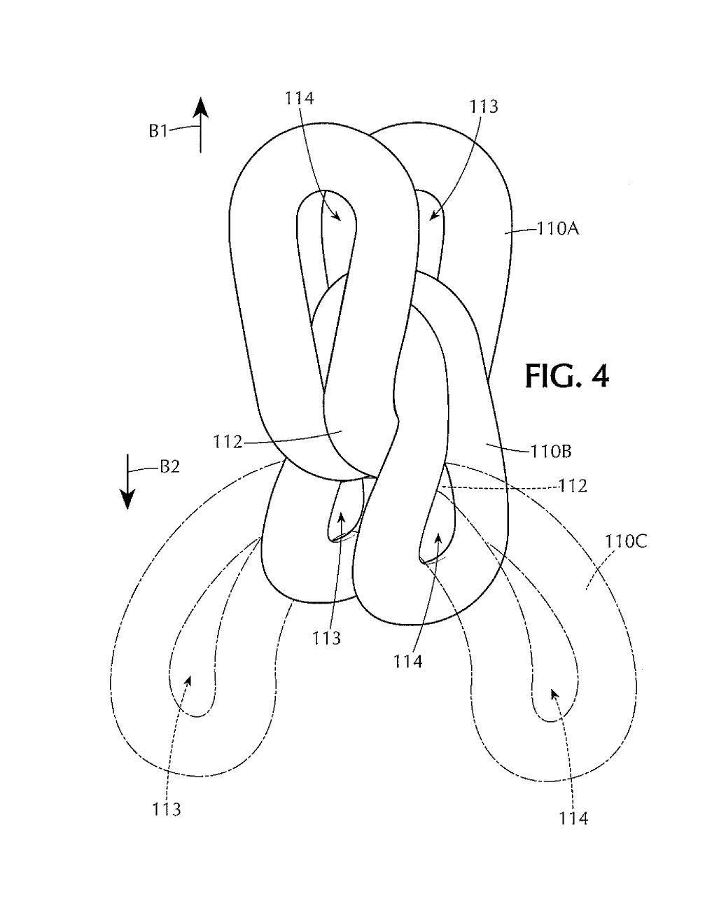

FIGS. 1-2 are elevational views of a play toy, generally designated at 100, according to one embodiment of the present invention. In FIG. 1, the play toy 100 is shown in a natural, unstretched configuration or state, and in FIG. 2 the play toy 100 is shown in a stretched configuration or state (i.e., stretched in directions shown by arrows A1 and A2). The play toy 100 is constructed of link members 110 that are linked together to form at least one stretchable link body or part 120 having a preselected cross-sectional shape and arranged in a preselected structural configuration, such as shown in FIGS. 1-2, for example. The link body 120 has two end link members 110 and a preselected number of additional link members 110 arranged therebetween (i.e., six link members 110 in total in embodiment of FIGS. 1-2). End portions 130 of each of the two end link members 110 are secured together in a suitable manner (e.g., tied) to form the link body 120 into an integral, unitary structure. The link members 110 are shown folded and arranged relative one another to form the link body 120 as further described below with reference to FIG. 4.

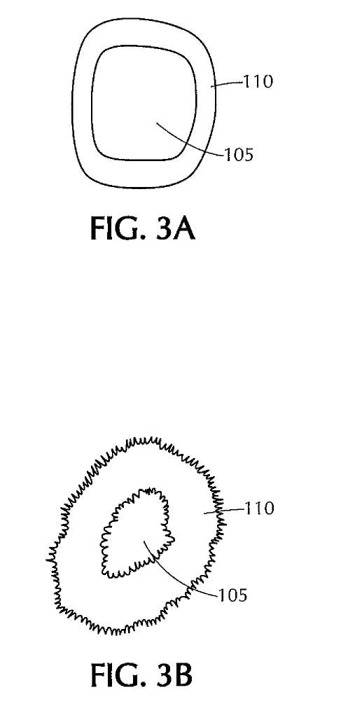

FIGS. 3A-3B show two exemplary embodiments of link members 110, each in a state prior to being folded and arranged relative to one another or to other link members 110 to form the link body 120 of the play toy. Each of the link members 110 has a generally ring-shaped configuration, such as in the general form of a doughnut (hereinafter “donut”), having a generally centered aperture 105. The dimensions of each of the link members 110 may be varied and selected depending on the desired dimensions for the resulting link body 120. The materials that can be used for the link members 110 include fleece, plush-like materials, thermoplastic rubber (TPR), denier nylons, recycled materials, all types of fabric and synthetic materials, or combinations of these and other materials. For example, the link member 110 may be made of TPR as shown in FIG. 3A, or of a plush-like fabric material as shown in FIG. 3B.

It will be appreciated that the link body 120 may be formed by linking link members 110 made of the same material, or by linking link members 110 made of two or more different materials with various linking arrangements. For example, the link body 120 may be formed by linking together a first group of link members 110 made of a first material (e.g., TPR) and a second group of link members 110 made of a second material (e.g., a plush fabric) different from the first material. The link members 110 within each group may be linked together consecutively as a group, and then the two groups are linked together to form the link body. Alternatively, link members 110 from each group may be arranged in an alternating manner (e.g., two TPR link members linked together which is linked to two plush fabric link members linked together, etc.), or in any desired arrangement pattern to form the link body 120.

According to the present invention, by configuring the link members 110 in the general form of a donut (hereinafter also “donut configuration”), the link members can be easily made from any type of material, and can be sewn, cut, moulded, bonded, glued and/or stuffed, for example, into the donut configuration, thereby making it easy to manufacture the link member. Linking of link members 110 in the general form of a donut is easy and can be done by hand and does not require expert training on machines, thereby reducing manufacturing costs. The donut configuration also makes it easy to connect (i.e., link) together a combination of link members 110 made of different materials. The donut configuration also facilitates folding of the link members 110, as described below with reference to FIG. 4, and even twisted into a figure-8 configuration prior to being folded and then linked. The link body 120 formed of the link members 110 with the donut configuration can also be easily combined with various other play objects, such as tennis balls and rubber rings, as further described below.

It will also be appreciated that another advantage of the donut configuration is that it permits the link members 110 to easily connect (link) to one another, thereby reducing, and in some cases eliminating, the need for stitching. In conventional animal play toys primarily formed of stitched members, the stitching is usually the first part of the play toy to fail under stress.

FIG. 2 illustrates yet another important advantage achieved by forming the link members with a donut configuration. When the link body 120 is stretched by pulling from both ends, as denoted by arrows A1 and A2 in FIG. 2, the link members 110 form gaps S which reduce the overall stress applied to the play toy and avoids failure. When the link body 120 is part of a play toy for animals, such as dogs, the gaps S resulting from the stretching of the link body 120 formed of link members 110 having a donut configuration will allow the dogs' teeth to pass through the gaps S with some areas of the material forming the link members 110 brushing up against the teeth to clean them. The resulting gaps S also make it easy to pass materials through the gaps, such as arms and legs of a character linked toy or just plain rope, to thereby provide the play toy with a preselected structural configuration.

The donut configuration of the link members 110 which are linked together also allows the link body 120 to exhibit a bungee-like stretch that is gentle and promotes play that is safe, particularly when the play toy is used by pets. This is in contrast to conventional solid rope toys that when tugged by the pet owner during play can cause tooth loss and neck injury to the pet. Tugging is one of the critical play patterns for pets, such as dogs, and it needs to be made safe. The present invention accomplishes this by providing a play toy with at least one link body that is formed by linking together link members in the general form of a donut as disclosed herein.

FIG. 4 is a perspective explanatory view of the stretchable link body 120 shown in an intermediate stage of manufacture to illustrate an example of the process for linking the link members together to form the link body. To facilitate explanation, the link members are denoted by 110A, 110B and 110C in FIG. 4.

As shown in FIG. 4, each of the link members 110A-110C is folded generally about its mid-section 112 to provide two generally aligned looped portions 113, 114. Link members 110A and 110B are linked together at the corresponding mid-sections 112 thereof so that the aligned looped portions 113, 114 of link member 110A extend in a first direction denoted by arrow B1 and the aligned looped portions 113, 114 of link member 110B extend in a second direction denoted by arrow B2 opposite to the first direction. Link member 110C, which is denoted in dashed line, is linked to link member 110B by passing through the aligned looped portions 113, 114 of link member 110B. In the example of FIG. 4, link member 110A denotes an end (last) link member of the link body. A preselected number of additional link members may be linked together continuing from the link member 110C by passing through the corresponding aligned looped portions of the previously linked link member as described above. When a desired length is achieved for the link body 120, an end (last) link member is linked to the previous link member in the same manner as described above for the linking of link members 110A and 110B. End portions corresponding to the looped portions of each of the end link members, including the link member 110A, are then secured together in a suitable manner, such as described above for end portions 130 of the end link members 110 shown in FIGS. 1-2, to form the link body 120 into an integral, unitary structure.

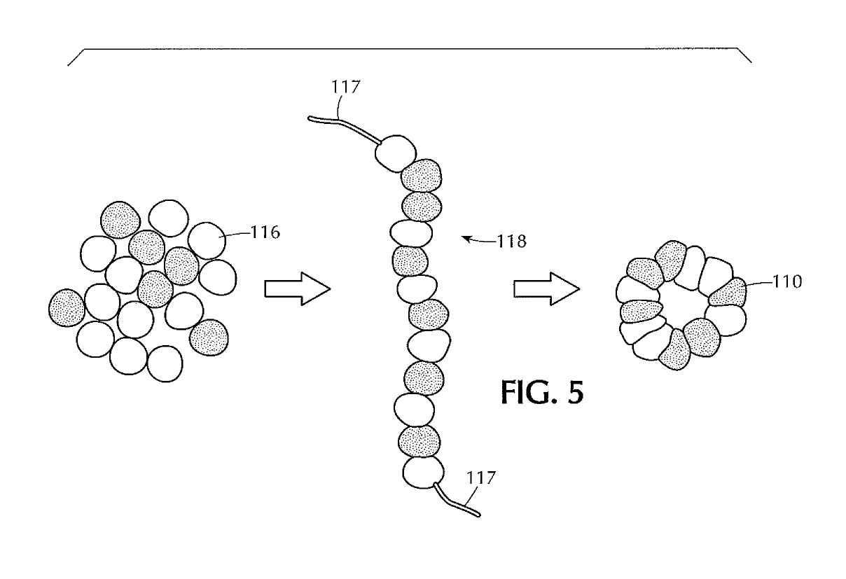

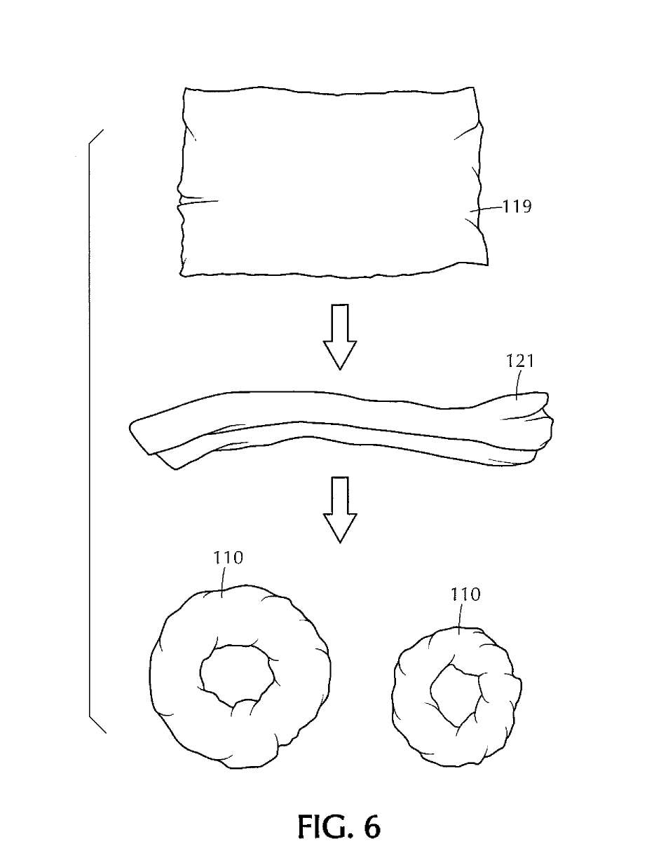

FIGS. 5 and 6 are diagrammatic views illustrating two exemplary embodiments of the process for making the link members 110 for the link body 120.

In the embodiment shown in FIG. 5, multiple circular-shaped objects 116 (e.g., pom poms) are used as a starting material for making each link member 110. The circular-shaped objects 116 are first assembled on a string 117 as denoted generally at 118. The ends of the string 117 are then tied together to form the link member 110 with a generally ring-shaped configuration, such as in the general form of a donut as described above. A preselected number of the link members 110 shown in FIG. 5 can then be linked together as described above with reference to FIG. 4, for example, to form the stretchable link body 120.

In the embodiment shown in FIG. 6, a piece of fabric material 119 (e.g., a fleece panel) is used as the starting material for making each link member 110. The piece of fabric material 119 is first folded and then twisted as shown at 121. The twisted fabric material 119 is then sewn to form the link member 110 with a generally ring-shaped configuration, such as in the general form of a donut as described above. Link members 110 of different dimensions may be formed, such as shown in FIG. 6, by varying the size of the piece of fabric material 119 and/or by varying the extent of folding and twisting of the fabric material 119 prior to sewing to form the link member 110. A preselected number of the link members 110 shown in FIG. 6 (e.g., having the same or different dimensions) can then be linked together as described above with reference to FIG. 4, for example, to form the stretchable link body 120.

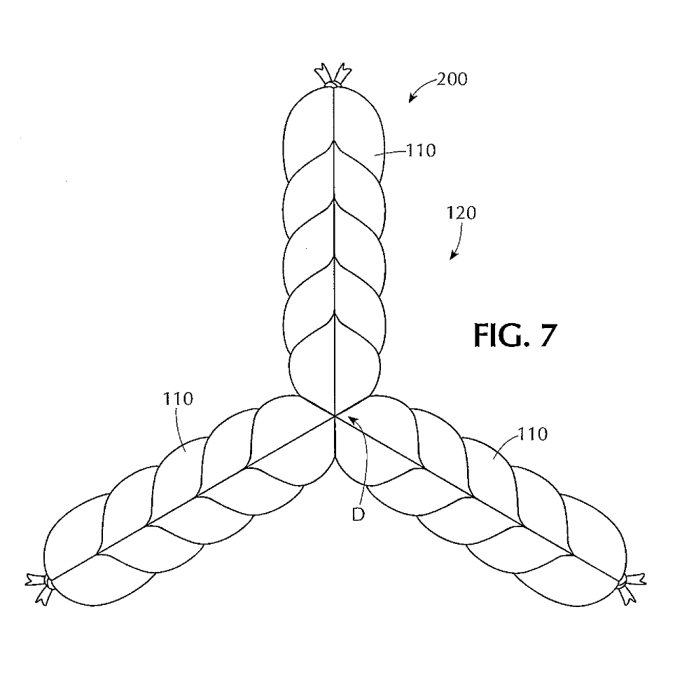

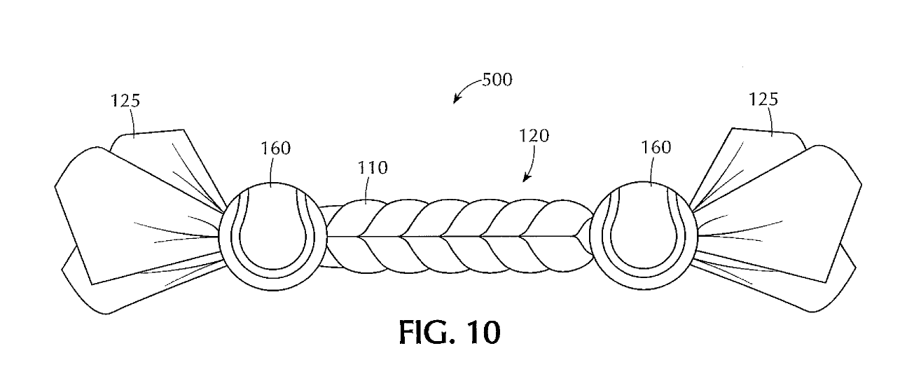

FIG. 7 is an elevational view of a play toy, generally designated at 200, according to another embodiment of the present invention. The play toy 200 is formed using three of the stretchable link bodies 120 described above with reference to FIGS. 1-2. The link bodies 120 are secured together in a suitable manner at an intersection area, generally designated at D in FIG. 7, by tying or sewing together end portions of corresponding end link members 110 of the link bodies 120, and/or using a suitable adhesive, for example. The link bodies 120 of the play toy 200 may also be combined with objects (e.g., balls), for example, in a manner described below for the embodiment of FIG. 10.

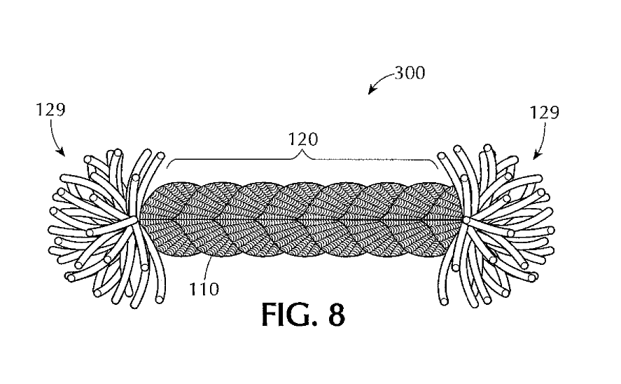

FIG. 8 shows a play toy, generally designated at 300, according to another embodiment of the present invention. The play toy 300 has a single stretchable link body 120 as described above with reference to FIGS. 1-2. The link body 120 in FIG. 8 is illustrated as being made of a fabric material, such as denier nylon. To each of the terminal ends of the link body 120 (i.e., the end portion of each of the end link members 110), a hair-like structure 129 is provided for enhancing the playing effect of the play toy 300. The play toy 300 is particularly adapted for use as a cat toy.

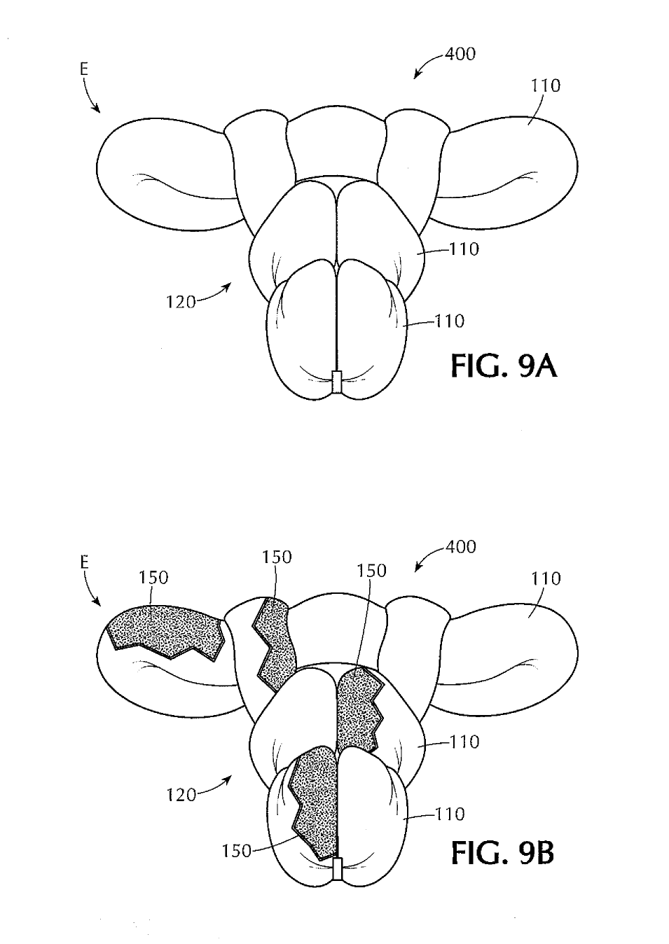

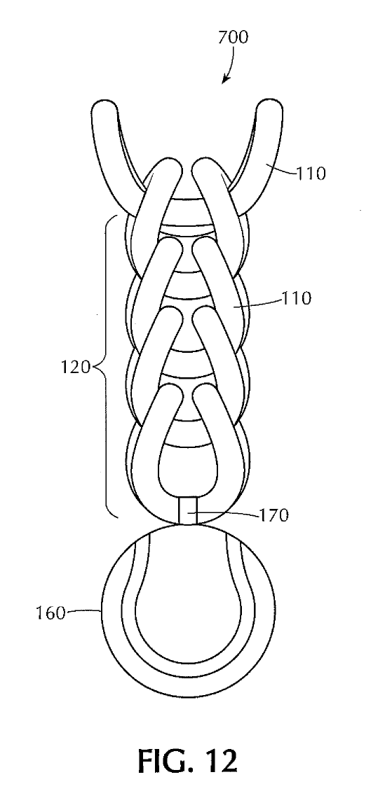

FIGS. 9A-9B show another embodiment, generally designated at 400, of a play toy according to the present invention. The play toy 400 has a single stretchable link body 120 including a preselected number (e.g., four in FIGS. 9A-9B) of link members 110 each having a generally ring-shaped configuration, such as in the general form of a donut, as described above for the embodiment of FIGS. 1-2. In this embodiment, the lower link member 110 (the last link member from the top of the link body shown in each of FIGS. 9A-9B) corresponds to one of the end link members of the link body 120, with end portions of the lower end link member being connected (e.g., tied) together as described above for link member 110A in FIG. 4. In FIGS. 9A-9B, the end portions of the lower end link member 110 are shown connected together with a tie member, such as denoted by reference numeral 170 in the embodiment of the play toy described below with reference to FIG. 12. The upper link member 110 of the link body 120, denoted by arrow E in FIGS. 9A-9B, corresponds to the other of the end link members of the link body 120 and is shown in a configuration preparatory for the end portions thereof being connected (e.g., tied) together as described above for the lower end link member 110. As shown in FIG. 9B, each of the link members 110 of the link body 120 forming the play toy 400 is filled with a suitable filler material 150 including cotton, synthetic fibers, and the like, to give consistent thickness and softness to the link members.

FIG. 10 shows another embodiment of a play toy, generally designated at 500, according to the present invention. The play toy 500 includes a single stretchable link body 120 as described above with reference to FIGS. 1-2. In this embodiment, the link body 120 is combined with two play objects, such as tennis balls 160, integrally secured to end portions of the link body as shown. Any suitable method may be employed for securing the tennis balls 160 to the link body 120. For example, terminal ends 125 of the link body 120 may be passed through respective openings (not shown) of the tennis balls 160 and captively retained or secured inside of the tennis ball such as by using an adhesive glue or other suitable bonding agent.

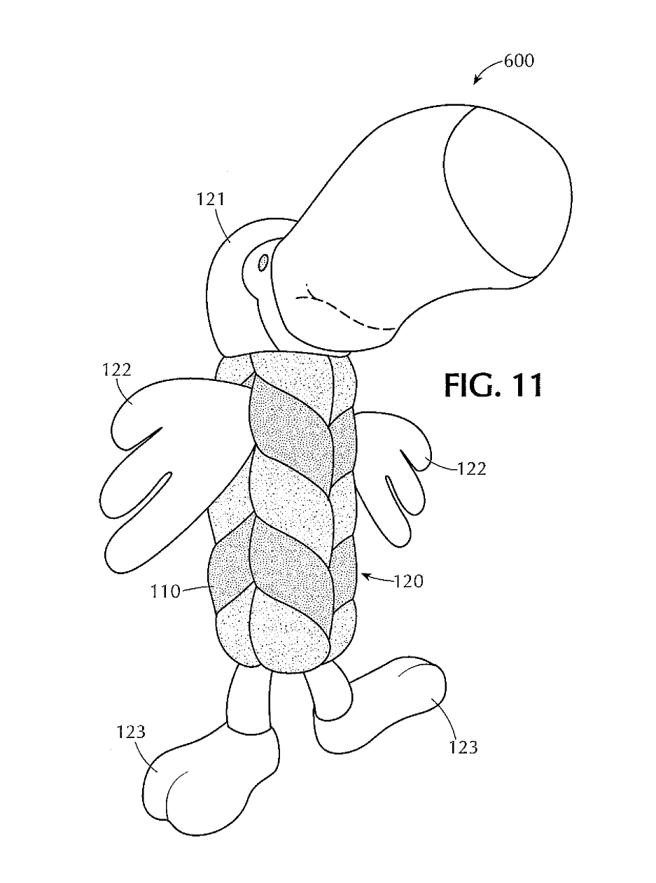

FIG. 11 shows another embodiment of a play toy, generally designated at 600, according to the present invention. The play toy 600 includes at least one stretchable link body 120 as described above with reference to FIGS. 1-2. In this embodiment, the play toy 600 is in the form an animate figure. More specifically, the play toy 600 includes a mid-section or center body corresponding to the link body or part 120, a head 121, two arm/hands 122 and feet/legs 123 and is shaped to imitate the physical characteristics of the animate figure (e.g., a parrot). The head 121, arms/hands 122 and feet/legs 123 correspond to non-linked parts (i.e., parts which are not formed of linked link members) of the play toy 600 and may be filled with cotton batting or other filler to give consistent thickness and softness to these parts. The non-linked parts are integrally attached to various parts of the link body 120, such as by stitching.

FIG. 12 shows another embodiment of a play toy, generally designated at 700, according to the present invention. The play toy 700 includes a stretchable link body 120 formed of a preselected number of link members 110 each having a generally ring-shaped configuration, such as in the general form of a donut, as described above for the embodiment of FIGS. 1-2. FIG. 12 illustrates an alternative process for linking the link members 110 compared to the process of linking the link members 110 described above with reference to FIG. 4. In the linking body 120 of FIG. 12, none of the link members 110 are shown to be linked together at respective mid-sections thereof, as described above for members 110A and 110B in FIG. 4. Instead, in FIG. 12 the link members 110 are consecutively linked by each folded member 110 being passed through the aligned looped portions 113, 114 of an adjacent member 110 in the manner described above and shown in FIG. 4 for members 110B and 110C. The link body 120 of the play toy 700 is combined with one play object, such as a tennis ball 160, integrally secured to a terminal end portion of one of the end link members 110 (i.e., the lowest link member of link body 120 shown in FIG. 12). Any suitable method may be employed for securing the tennis ball 160 to the link body 120. For example, the tennis ball 160 may by secured to the end link member 110 using a tie 170 that wraps around the terminal end portion of link member 110 and that is integrally connected to the tennis ball 160 by an adhesive or other suitable fastener.

It will be appreciated that the stretchable link bodies 120 for the play toy according to the present invention may be formed of link members having a construction other than as described above with reference to foregoing embodiments. For example, hair bands, each having a generally ring-shaped configuration, such as in the general form of a donut, may be linked together in any manner described above with reference to the foregoing embodiments to form at least one stretchable link body 120 for the play toy which is particularly suitable for use as a cat toy.

As described above, the materials for the link members 110 forming the stretchable link body 120 for the play toy according to the present invention may include fleece, plush-like materials, thermoplastic rubber (TPR), denier nylons, recycled materials, all types of fabric and synthetic materials, or combinations of these and other materials. The link part and/or non-linked part may also be filled with a suitable filler material including cotton, synthetic fibers, and the like. For example, the play toy 600 shown in FIG. 11 is preferably made of a plush fabric material (i.e., a “plush toy”).

In the embodiments described herein, the plush material is preferably a hypoallergenic plush material that is soft to the touch, such as sheepskin, fleece, felt, cotton, velour, boa fabric, tricot fiber, polyester fiber, cotton/polyester blends, or a combination thereof. Both elastic and inelastic types of plush materials are suitable for the link bodies described above. When an inelastic (i.e., non-stretch) plush material, such as acrylic or modified acrylic pile, is used, the various play modes described above which require stretching of the link body is still accomplished due to the construction and manner of linking the link bodies which permit stretching between the link members having the donut configuration as described above.

The play toys described above are suitable for pets for playing fetch and pulling, such as dogs. The plush toys, in particular, are very soft and well suited for puppies with new developing teeth. Furthermore, plush materials also allow for the creation of figures and characters such as described above with reference to FIG. 11. The play toys described above are also suitable for use by small children during play and by individuals with special needs, with the link bodies being easily grasped and manipulated by small hands of children.

The play toys according to the present invention are also particularly adapted for use as a therapy device by individuals with special needs. For example, as a therapy device the play toy according to the present invention can be used as a hand fidget, which instantly calms sensory seekers, as well as a fine motor skill builder. This is further facilitated by the link bodies of the play toy according to the present invention which can be easily grasped and manipulated by individuals with special needs having immature grips.

The configurations and materials of the play toys according to the foregoing embodiments of the present invention allow for the placement of one or more of conventional sound producing devices arranged in the link part and/or non-linked part for producing an audible noise or sound upon compression or a shaking movement of the sound producing device via the link part and/or non-linked part. For example, one or more “squeekers” may be placed within the various link parts and/or non-linked parts of the three-dimensional animate figure shown in FIG. 11, such as the body, head, hands/arms and feet/legs, to emit a squeaky sound when squeezed and thereby enhance the attractiveness of the play toy.

The play toy according to the present invention is also suitable for use as an advertising device, with advertising indicia being provided on one or more of the various link parts and/or non-linked parts.

Those skilled in the art will readily appreciate that the stretchable link bodies of the play toys of the present invention described herein may also be used to fabricate other types of play toys for pets, children, and individuals with special needs. For example, one or more of the link bodies may be used to fabricate bone-shaped objects used as chew toys or disc-shaped flying objects used as fetch toys by pets, as well as various objects, characters, and animate and inanimate figures for use by children and individuals with special needs during play and/or for use as therapy devices. Such play toys may also be scaled to accommodate the pets, children and individuals with special needs of different age or size. In addition, the link bodies may also be used in combination with components (e.g., balls or other pre-formed members) made using ballistic nylon, canvas, vinyl, polyvinyl chloride (PVC), and the like materials.

The previous description of the invention is provided to enable any person skilled in the art to make or use the invention. Various modifications to the invention will be readily apparent to those skilled in the art, and the principles defined herein may be applied to other variations without departing from the spirit or scope of the invention. Thus, the invention is not intended to be limited to the examples described herein but is to be accorded the widest scope consistent with the principles and novel features disclosed herein.

What is claimed is:

1. A play toy comprising: a plurality of link members each having a generally ring-shaped configuration and being linked together to form at least one stretchable link body having a preselected cross-sectional shape and arranged in a preselected structural configuration.

2. A play toy according to claim 1; wherein the generally ring-shaped configuration of each of the link members is in the general form of a donut.

3. A play toy according to claim 1; wherein each of the link members is folded generally about a mid-section thereof to provide two generally aligned looped portions.

4. A play toy according to claim 3; wherein the plurality of link members comprise a plurality of pairs of adjacent link members; and wherein each pair of adjacent link members are linked together either at corresponding mid-sections thereof, or by one of the pair of adjacent link members passing through the aligned loop portions of the other of the pair of adjacent link members such that the looped portions of the other of the pair of adjacent link members are positioned in the region of the mid-section of the one of the pair of adjacent link members.

5. A play toy according to claim 1; wherein the at least one link body is connected to at least one non-linked part to form a three-dimensional-shaped play toy.

6. A play toy according to claim 5; wherein the non-link part and each of the link members forming the link body are made of a material selected from the group consisting of fleece, plush-like materials, thermoplastic rubber (TPR), denier nylons, recycled materials, all types of fabric and synthetic materials, and combinations thereof.

7. A play toy according to claim 1; wherein each of the link members is filled with a filler material.

8. A play toy according to claim 7; wherein the filler material is selected from the group consisting of cotton, synthetic fibers, a plastic tubing, a pre-molded structure, or a combination thereof.

9. A play toy according to claim 1; wherein each of the link members is made of a material selected from the group consisting of fleece, plush-like materials, thermoplastic rubber (TPR), denier nylons, recycled materials, all types of fabric and synthetic materials, and combinations thereof.

10. A play toy according to claim 1; wherein the link members are filled with a filler material.

11. A play toy according to claim 10; wherein the filler material is selected from the group consisting of cotton, synthetic fibers, a plastic tubing, a pre-molded structure, or a combination thereof.

12. A play toy according to claim 1; further comprising at least one play object coupled to the link body.

13. A play toy according to claim 12; wherein the play object comprises one or more tennis balls, rubber balls, pre-formed rubber or plastic figures, or a combination thereof.

14. A play toy according to claim 1; wherein the at least one stretchable link body comprises a plurality of stretchable link bodies connected together.

15. A play toy according to claim 1; wherein the plurality of link members forming the stretchable link body are made of at least two different types of materials.

16. A method of fabricating a play toy, comprising: providing a plurality of link members each having a generally ring-shaped configuration; and linking the link members together relative one another to form at least one stretchable link body having a preselected cross-sectional shape and arranged in a preselected structural configuration.

17. A method according to claim 16; wherein the generally ring-shaped configuration of each of the link members is in the general form of a donut.

18. A method according to claim 16; further comprising folding each of the link members about a mid-section thereof to provide two generally aligned looped portions; and wherein the linking comprises either linking together each pair of adjacent link members at corresponding mid-sections thereof or linking each pair of adjacent link members by passing one of the pair of adjacent link members through the aligned loop portions of the other of the pair of adjacent link members such that the looped portions of the other of the pair of adjacent link members are positioned in the region of the mid-section of the one of the pair of adjacent link members.

19. A method according to claim 16; further comprising connecting at least one non-linked part to the at least one stretchable link body.

20. A method according to claim 16; wherein each of the link members is made of a material selected from the group consisting of fleece, plush-like materials, thermoplastic rubber (TPR), denier nylons, recycled materials, all types of fabric and synthetic materials, and combinations thereof.
